(19) United States
(12) Patent Application Publication
(10) Pub. No.: US 2015/0039797 A1
(43) Pub. Date: Feb. 5, 2015

(54) REMOVABLE EXPANSION INTERFACE DEVICE

(71) Applicant: PORTWELL INC., New Taipei City (TW)

(72) Inventor: Ming-Hsin Tsai, New Taipei City (TW)

(73) Assignee: PORTWELL INC., New Taipei City (TW)

(21) Appl. No.: 13/958,097

(22) Filed: Aug. 2, 2013

(51) Int. Cl. G06F 13/40

(52) U.S. Cl. CPC G06F 13/409
USPC 710/301

(57) ABSTRACT

A removable expansion interface device comprising: a motherboard; a system slot which is installed on and electrically connected to the motherboard and develops an accommodation space; a carrier which is a printed circuit board held in the accommodation space and electrically connected to the system slot; an expansion slot installed on and electrically connected to the carrier and develops a plug-in space. As such, the present invention relies on removable design to match an interface device to be used and realize lowered costs and spatial and economic efficiency. Furthermore, the present invention is based on a motherboard without extra cost and has significant advantages such as applications of new storage devices, expansion of other functions, time and cost efficiency, lowered complexity, and industrial applicability.

### BACKGROUND OF THE INVENTION

1. Field of the Invention

The present invention relates to a card slot interface structure, particularly a removable expansion interface device featuring a removable expansible interface and spatial and economic efficiency in manufacture and usage.

2. Description of the Related Art

The principal IT storage devices or media such as digital camera, recording pen, and music player rely on mature technology for manufacture of compact flash memories, particularly CF cards (Compact Flash cards), CFast cards, CFEX cards, or CF-SATA cards, which are based on SATA interfaces (or other available interfaces) for data storages or boot disk applications and widely adopted in various IT products, and even taken as host computers' system hard drives substituting conventional IDE hard discs because of their multiple advantages including good compatibility, high access speed, high capacity, ultra-low power consumption, compact structure, dust prevention, good vibration strength, and impact resistance.

A conventional CF module (plug-in module) structure as shown in FIG. 1 and the technology comprises: a CF slot 94, which is installed on a motherboard 90 and coupled with a CF card 95; a CPU socket 91 prepared on the motherboard 90 for a CPU to be mounted; expansion slots 92 (e.g., PCI bus); a chip 93; and relevant electronic components or circuits. As a high-speed and high-stability transmission interface for data access, the conventional CF module still has some drawbacks. For example, the conventional CF slot 94 in which only a CF card (i.e., CF module) for a single function can be held is not an ideal design for other storage interfaces incompatible with each other CF-SATA card, CFast card, or CFEX card to he installed on the motherboard 90) because that would occupy or double up more spaces on the motherboard which consume costs and complicate design of a motherboard; each of these storage interfaces has fixed dimensions and pin counts which limit expandability and functions. Furthermore, it costs a lot to change a client's existing motherboard on which old storage devices are installed by a new one with new storage devices mounted. Against this background, an existing interface device deserves to be corrected because a client's lowered inclination to employ a new storage device is unfavorable to development of new storage media technology and promotion of work efficiency. Thus, how to correct drawbacks related to applications of conventional storage interfaces should be further studied by the persons skilled in the art.

Having considered defects and unideal structural design of a conventional storage interface, in usage and operation for a long time, the inventor offered a solution and manufactured the present invention of a removable expansion interface device featuring selectivity, expandability, and effectiveness for the general public and development of the industry.

### SUMMARY OF THE INVENTION

The object of the present invention is to provide a removable expansion interface device with removable design matching an interface device to be used, save costs, and realize spatial and economic efficiency.

The other object of the present invention is to provide a removable, expansion interface device which is based on a motherboard without extra cost and has advantages such as applications of new storage devices, expansion of other functions, time and cost efficiency, lowered complexity, and industrial applicability.

The present invention comprises the following technical measures to realize the above purposes: a motherboard; a system slot which is installed on and electrically connected to the motherboard and develops an accommodation space; a carrier which is a printed circuit board inserted into the accommodation space and electrically connected to the system slot; an expansion slot which is installed on and electrically connected to the carrier and develops a plug-in space.

For technical features and effects in terms of the present disclosure completely comprehended and recognized, the preferred embodiments and accompanying drawings are thoroughly described hereinafter.

### BRIEF DESCRIPTION OF THE DRAWINGS

FIG. 1 is a schematic view illustrating a conventional CF Card used in a motherboard.

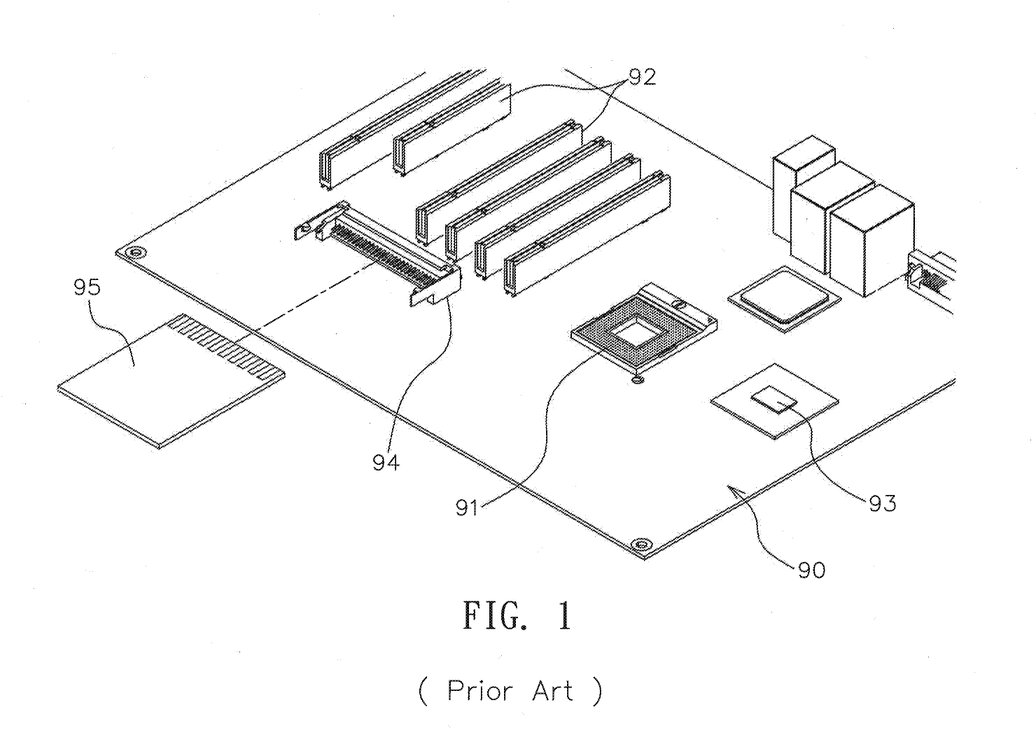

FIG. 2 is a schematic view illustrating a CFEX slot and a CFEX card in the present invention.

FIG. 3 is a schematic view illustrating configurations of a terminal pin unit in a CFEX slot of the present invention.

FIG. 4 is a schematic view illustrating the present invention.

### DETAILED DESCRIPTION OF THE PREFERRED EMBODIMENTS

The present invention presents a removable expansion interface device installed on a motherboard and comprising: a system slot on the motherboard; a carrier which is used in the motherboard, inserted into the system slot, and provided with (a) an expansion slot, i.e., a CF slot, a CFast slot, a CFEX slot or a CF-SATA slot, with which a CF card, a CFEX card, a CF-SATA card or a CFast card is coupled, and (b) a WiFi module or a IPMI module.

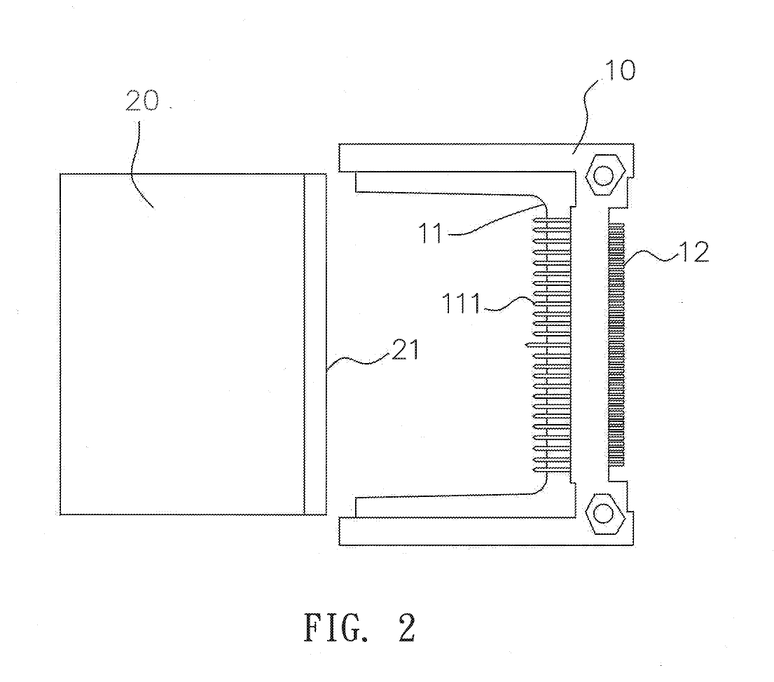

The CFEX slot, the CF-SATA slot, or the CFast slot and the corresponding cards are described and defined in the following sections. Refer to FIG. 2 that illustrates a CFEX slot 10 (CF Expansion slot and CFEX slot for short) to be electrically connected to circuits of a motherboard which is a printed circuit board (carrier) for installation of the CFEX slot 10 and not limited to the motherboard of the present invention: the CFEX slot 10 similar to a common CF slot is coupled with a CFEX card 20 (CF Extension card and CFEX card for short) for stable signal communication between the CFEX card 20 and circuits on the motherboard via the CFEX slot 10; the CFEX slot 10 presented herein comprises an inward card built-in end 11 and an outward, circuit connecting end 12: the circuit connecting end 12 is electrically connected to the motherboard; the card built-in end 11 is internally provided with a terminal pin unit 111 which allows one side to link the outward circuit connecting end 12 of the CFEX slot 10.

Specifically, the CFEX card 20 has an interface connector 21 used to match and link the terminal pin unit 111: the interface connector 21 exerts its functions defined as per actual functionality of the CFEX card 20; the terminal pin unit 111 exerts functions of all pins defined as those of the interface connector 21 on the CFEX card 20. Output signals transmitted from the CFEX card 20 are sent to the terminal pin unit 111 at the CFEX slot 10 via the corresponding interface connector 21, the outward circuit connecting end 12 of the CFEX slot 10 via the terminal pin unit 111, and circuits of the motherboard sequentially. Comparatively, input signals transmitted from circuits of the motherboard are forwarded to the inward terminal pin unit 111 via the outward circuit connecting end 12 of the CFEX slot 10 and the corresponding interface connector 21 via the terminal pin unit 111 for completion of signal transmission between the motherboard's circuits and the CFEX card 20.

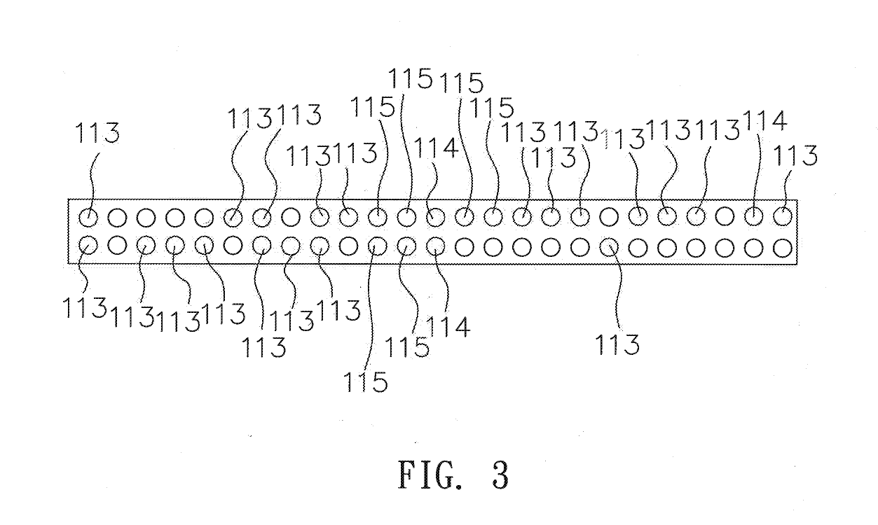

The number of pins available in the terminal pin unit 111. which is held in the card built-in end 11 can be freely decided according to realistic demands. Refer to FIG. 3 which illustrates 50 pins of the terminal pin unit 111 held in the card built-in end 11 in the embodiment. Depending to realistic functions, the terminal pin unit 111 can be defined and classified as ground pins 113, power pins 114 and functional pins 115. A terminal pin which is defined as one of the ground pins 113 implies the circuit connecting end 12 behind the terminal pin is electrically connected to ground circuits on the motherboard; a terminal pin which is defined as one of the functional pins 115 implies the circuit connecting end 12 behind the terminal pin is electrically connected to functional circuits on the motherboard for executing a specific function; a terminal pin which is defined as one of the power pins 114 implies the circuit connecting end 12 behind the terminal pin is electrically connected to power circuits on the motherboard.

The circuit connecting end 12 linking the terminal pin unit 111 of the CFEX slot 10 can be electrically connected to either PCI circuits or PCI Express circuits on the motherboard for more functional applications.

As examples presented in FIG. 3, the pins, e.g., ground pins 113, power pins 114 and functional pins 115, can be adjusted and connected to different circuits for distinct functions as per realistic functionality and demands but not limited to applications in these examples.

It can be seen from above descriptions that the functions of the CFEX card 20 and the CFEX slot 10 in the present invention can be flexibly defined according to pins of the terminal pin unit 111. Moreover, the interface connector 21 based on realistic functionality of the CFEX card 20 has distinct functions at pins corresponding to those of the terminal pin unit 111 so that the CFEX card 20 is internally provided with either a single module or multiple modules, for example, wireless communications module, remote control module, hardware debugging module, and hardware monitoring module, each of which makes both the CFEX card 20 and the CFEX slot 10 exert flexible functions.

Like design of a conventional CF card, the CF-SATA slot and the CF-SATA card also have 50 pins for transmission of SATA signals, i.e., 4 of 50 pins in a CF card are used to receive SATA signals, and appearances of a common CF slot and a common CF card, respectively.

The specifications of a CFast card and a CFast slot should refer to CFast standard specifications constituted by the CompactFlash Association: a CFast slot (CFast card) has appearance identical to that of a common CF slot (CF card); a CFast card has 7 of 50 pins for reception of SATA signals and 17 for power according to CFast standard specifications.

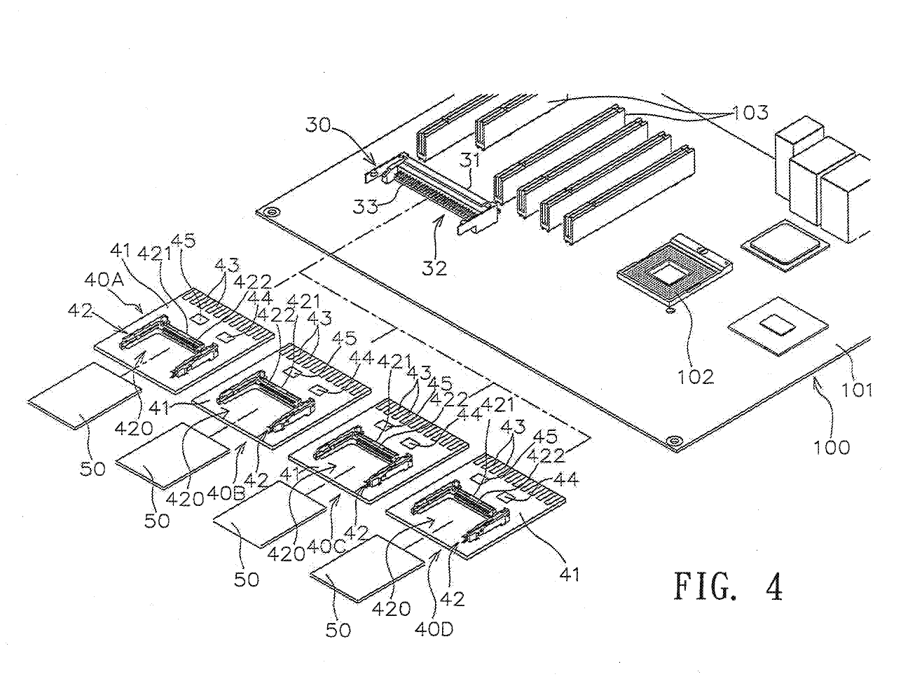

Refer to FIG. 4 which illustrates the present invention of a removable expansion interface device comprising a motherboard module 100 and a system slot 30: the motherboard module 100 comprises a motherboard 101 on which the system slot 30 is installed, a CPU socket 102 mounted on the motherboard 101 for a CPU, a plurality of expansion slots 103 (e.g., PCI bus), and relevant electronic components or circuits. The system slot 30 is provided with an outward system circuit connecting end 31 and an inward accommodation space 32; the motherboard 101 is provided with a SATA signal circuit to which the system circuit connecting end 31 is connected; the accommodation space 32 is prepared for an expansion interface module (described hereinafter); the system slot 30 has an expansion terminal connection end 33 situated inside the accommodation space 32 and electrically connected to the outward system circuit connecting end 31.

The system slot 30 has a size which is no less than that of a CF slot and includes, without limitation, 50 pins. Preferably, the system slot 30 is larger than a CF slot and has more than 50 pins for variously defined pins, connections to more circuits, diversified functions, and no limitation in space or pin counts.

Furthermore, the motherboard 101 is provided with multiple signal transmission circuits to which the system circuit connecting end 31 of the system slot 30 is connected for more functions designed in the present disclosure. For example, the motherboard 101 is provided with a PCIE (PCT Express) signal circuit, an I²C (Inter-Integrated Circuit) signal circuit, an SMBUS (System Management Bus) signal circuit, or an LPC (Low Pin Count) signal circuit. Moreover, the system circuit connecting end 31 of the system slot 30 is connected to the PCIE signal circuit, the I²C signal circuit, the SMBUS signal circuit, or the LPC signal circuit on the motherboard 101. The signal transmission circuit designed on the motherboard 101 is used to transmit signals including, without limitation, those signals hereinbefore as examples. As shown in FIG. 4, the expansion interface module can be a CF interface module 40A, a CFast interface module 40B, a CFEX interface module 40C, or a CF-SATA interface module 40D.

The details of the CF interface module 40A are presented hereinafter. The CF interface module 40A comprises a carrier 41 and an expansion slot 42 which is a CF slot installed on and electrically connected to the carrier 41 in the embodiment: the carrier 41 as a printed circuit board with a plurality of terminals 43 at its front end is held in the accommodation space 32 of the system slot 30 for electric connection between the terminals 43 and the expansion terminal connection end 33 and further comprises a WiFi (Wireless Fidelity) module 44 on which a WiFi chip is mounted or an IPMI (Intelligent Platform Management Interface) module 45 on which an IPMI chip is installed. Moreover, the expansion slot 42 which is a CF slot in the embodiment comprises an outward expansion circuit connecting end 421, an inward card terminal connection end 422, and a plug-in space 420; the carrier 41 can be designed with multiple signal transmission circuits to which the principal expansion circuit connecting end 421 is connected for more functions executed in the present disclosure. For example, the carrier 41 can comprise a SATA signal circuit, a PCIE (PCI Express) signal circuit, an IC (Inter-Integrated Circuit) signal circuit, an SMBUS (System Management Bus) signal circuit, or an LPC (Low Pin Count) signal circuit. Furthermore, the expansion circuit connecting end 421 is able to link the SATA signal circuit, the PCIE signal circuit, the I²C signal circuit, the SMBUS signal circuit, or the LPC signal circuit on the carrier 41, each of which is used to transmit signals exemplified in the present disclosure. The plug-in space 420 is prepared for holding an expansion card 50 (a CF card in the embodiment) and developing electric connection between the card terminal connection end 422 and the expansion card 50.

The details of the CFast interface module 40B are shown hereinafter. The CFast interface module 40B comprises a carrier 41 and an expansion slot 42 (a CFast slot in the embodiment) installed on and electrically connected to the carrier 41: the carrier 41 as a printed circuit board with a plurality of terminals 43 at its front end is held in the accommodation space 32 of the system slot 30 for electric connection between the terminals 43 and the expansion terminal connection end 33 and further comprises a WiFi (Wireless Fidelity) module 44 on which a WiFi chip is mounted or an IPMI (Intelligent Platform Management Interface) module 45 on which an IPMI chip is installed. Moreover, the expansion slot 42 which is a CFast slot in the embodiment comprises an outward expansion circuit connecting end 421, an inward card terminal connection end 422, and a plug-in space 420; the carrier 41 can be designed with multiple signal transmission circuits to which the principal expansion circuit connecting end 421 is connected for more functions executed in the present disclosure. For example, the carrier 41 can comprise a SATA signal circuit, a PCIE (PCI Express) signal circuit, an I²C (Inter-Integrated Circuit) signal circuit, an SMBUS (System Management Bus) signal circuit, or an LPC (Low Pin Count) signal circuit. Furthermore, the expansion circuit connecting end 421 is able to link the SATA signal circuit, the PCIE signal circuit, the I²C signal circuit, the SMBUS signal circuit, or the LPC signal circuit on the carrier 41, each of which is used to transmit signals exemplified in the present disclosure. The plug-in space 420 is prepared for holding an expansion card 50 (a CFast card in the embodiment) and developing electric connection between the card terminal connection end 422 and the expansion card 50.

The details of the CFEX interface module 40C are shown hereinafter. The CFEX interface module 40C comprises a carrier 41 and an expansion slot 42 (a CFEX slot in the embodiment) installed on and electrically connected to the carrier 41: the carrier 41 as a printed circuit board with a plurality of terminals 43 at its front end is held in the accommodation space 32 of the system slot 30 for electric connection between the terminals 43 and the expansion terminal connection end 33 and further comprises a WiFi (Wireless Fidelity) module 44 on which a WiFi chip is mounted or an IPMI (Intelligent Platform Management Interface) module 45 on which an IPMI chip is installed. Moreover, the expansion slot 42 which is a CFEX slot in the embodiment comprises an outward expansion circuit connecting end 421, an inward card terminal connection end 422, and a plug-in space 420; the carrier 41 can be designed with multiple signal transmission circuits to which the principal expansion circuit connecting end 421 is connected for more functions executed in the present disclosure. For example, the carrier 41 can comprise a SATA signal circuit, a PCIE (PCI Express) signal circuit, an I²C (Inter-Integrated Circuit) signal circuit, an SMBUS (System Management Bus) signal circuit, or an LPC (Low Pin Count) signal circuit. Furthermore, the expansion circuit connecting end 421 is able to link the SATA signal circuit, the PCIE signal circuit, the I²C signal circuit, the SMBUS signal circuit, or the LPC signal circuit on the carrier 41, each of which is used to transmit signals exemplified in the present disclosure. The plug-in space 420 is prepared for holding an expansion card 50 (a CFEX card in the embodiment) and developing electric connection between the card terminal connection end 422 and the expansion card 50.

The details of the CF-SATA interface module 40D are shown hereinafter, The CF-SATA interface module 401) comprises a carrier 41 and an expansion slot 42 (a CF-SATA slot in the embodiment) installed on and electrically connected to the carrier 41: the carrier 41 as a printed circuit board with a plurality of terminals 43 at its front end is held in the accommodation space 32 of the system slot 30 for electric connection between the terminals 43 and the expansion terminal connection end 33 and further comprises a WiFi (Wireless Fidelity) module 44 on which a WiFi chip is mounted or an IPMI (Intelligent Platform Management Interface) module 45 on which an IPMI chip is installed. Moreover, the expansion slot 42 which is a CFEX slot in the embodiment comprises an outward expansion circuit connecting end 421, an inward card terminal connection end 422, and a plug-in space 420; the carrier 41 can be designed with multiple signal transmission circuits to which the principal expansion circuit connecting end 421 is connected for more functions executed in the present disclosure. For example, the carrier 41 can comprise a SATA signal circuit, a PCIE (PCI Express) signal circuit, an I²C (Inter-Integrated Circuit) signal circuit, an SMBUS (System Management Bus) signal circuit, or an LPC (Low Pin Count) signal circuit. Furthermore, the expansion circuit connecting end 421 is able to link the SATA signal circuit, the PCIE signal circuit, the I²C signal circuit, the SMBUS signal circuit, or the LPC signal circuit on the carrier 41, each of which is used to transmit signals exemplified in the present invention. The plug-in space 420 is prepared for holding an expansion card 50 (a CF-SATA card in the embodiment) and developing electric connection between the card terminal connection end 422 and the expansion card 50.

The system slot 30 has a size, which is no less than that of the expansion slot 42 for accommodation of more pins, and more than 50 pins for variously defined pins, connections to more circuits, diversified functions, and no limitation in space or pin counts.

In other words, the expansion interface module can be the CF interface module 40A, the CFast interface module 40B, the CFEX interface module 40C, or the CF-SATA interface module 40D, each of which corresponds to the expansion card 50 to be held in the present invention, i.e., a. CF card, a CFast card, a CFEX card, or a CF-SATA card, respectively. For instance, the carrier 41 of the CFast interface module 40B should be inserted into the system slot 30 for holding a CFast card; the carrier 41 of the CFEX interface module 40C should be inserted into the system slot 30 fur holding a CFEX card with the carrier 41 of the CFast interface module 4013 removed from the system slot 30.

It can be seen from the above disclosure that the present invention of a removable expansion interface device based on removable design for an interface device to be used features lowered costs and spatial and economic efficiency. Moreover, the present invention based on a motherboard without extra costs is in favor of applications of new storage devices or expansion of other functions and realizes significant advantages such as time and cost efficiency, lowered complexity, and industrial applicability.

Accordingly, the present invention significantly meets patentability and is applied for the patent. However, the above descriptions are preferred embodiments which do not limit the scope of the present invention; any equivalent change or improvement in shapes, structure or features without departing from spirit of the present invention should be incorporated in claims herein.

What is claimed is:

1. A removable expansion interface device, comprising:
a motherboard;
a system slot which is installed on and electrically connected to said motherboard and develops an accommodation space;
a carrier which is a printed circuit board inserted into said accommodation space and electrically connected to said system slot;
an expansion slot installed on and electrically connected to said carrier and develops a plug-in space.

2. The removable expansion interface device according to claim 1 wherein said expansion slot can be a CF slot, a Mist slot, a CFEX slot, or a CF-SATA slot.

3. The removable expansion interface device according to claim 2 further comprises an expansion card which is inserted into said expansion slot's plug-in space and electrically connected to said expansion slot and can be a CF card, a CFast card, a CFEX card, or a CF-SATA card.

4. The removable expansion interface device according to claim 1 wherein said system slot comprises an outward system circuit connecting end and said motherboard is provided with a SATA signal circuit, a PCIE signal circuit, an I²C signal circuit, an SMBUS signal circuit, or an LPC signal circuit to which said system circuit connecting end is connected for transmission of SATA signals, PCIE signals, I²C signals, SMBUS signals, or LPC signals.

5. The movable expansion interface device according to claim 1 wherein said system slot has a size larger than that of said expansion slot.

6. The removable expansion interface device according to claim 1 wherein said system slot has more than 50 pins.

7. The removable expansion interface device according to claim 1 wherein said carrier further comprises a WiFi module on which a WiFi chip is mounted.

8. The removable expansion interface device according to claim 1. wherein said carrier further comprises an module on which an chip is mounted.

9. The removable expansion interface device according to claim I wherein said system slot comprises at least ground pins, power pins, and functional pins.

10. The removable expansion interface device according to claim I wherein said expansion slot comprises an outward expansion circuit connecting end and said carrier is provided with a SATA signal circuit, a PCIE signal circuit, an I²C signal circuit, an SMBUS signal circuit, or an LPC signal circuit to which said expansion circuit connecting end is connected for transmission of SATA signals, PCIE signals, I²C signals, SMBUS signals, or LPC signals.
